(19) United States
(12) Patent Application Publication
(10) Pub. No.: US 2014/0380494 A1
(43) Pub. Date: Dec. 25, 2014

(54) DRIVER RELATED DATA STORAGE SYSTEM AND METHOD

(71) Applicant: Xlerate Technologies Limited, Mt. Eden, Aukland (NZ)

(72) Inventors: Cyril Ovely, Mt Eden (NZ); Manojo Dolli, Epsom (NZ)

(73) Assignee: Xlerate Technologies Limited, Mt. Eden, Auckland (NZ)

(21) Appl. No.: 14/352,726

(22) PCT Filed: Oct. 16, 2012
(86) PCT No.: PCT/NZ12/00188

§ 371 Date: Apr. 18, 2014

(30) Foreign Application Priority Data
Oct. 18, 2011 (NZ) 595826

(51) Int. Cl. G06F 21/64; H04L 9/30

(52) U.S. Cl. CPC G06F 21/64; H04L 9/30
USPC 726/26

(57) ABSTRACT

A driver related data storage system comprising: a data generation module adapted to generate driver related data; an encryption module adapted to encrypt driver related data, a storage module adapted to store the encrypted driver related data, a code generation module adapted to generate a machine readable code based on the stored encrypted driver related data and an output module adapted to output the generated machine readable code.

### FIELD OF THE INVENTION

The present invention relates to a driver related data storage system and method. In particular, the present invention relates to a driver related data storage system and method that generates and outputs a machine readable code.

### BACKGROUND

In businesses where drivers are required to transport various goods and passengers, it is well known to utilise paper driver logbooks in order to track the driver's activities. For example, many countries have regulations related to monitoring the length of work periods or driving periods associated with the driver's activities as well as monitoring the rest periods associated with the driver. These logbooks are designed to manage driver fatigue and so improve highway safety for all users.

However, paper logbooks suffer from a number of disadvantages including the ability for unscrupulous drivers to manipulate the data entered into the logbooks. For example, the driver may enter incorrect or inaccurate data indicating that they have had longer periods of rest than actually taken. Further, the information entered into these paper logbooks is not easily transferable to third parties including employers and law enforcement officers.

Therefore, a number of countries have regulations that require the use of electronic logbooks. For example, in the EU a tachograph regulation exists where the electronic logbook is attached to the engine of the vehicle to automatically record distances travelled as well as rest times associated with the vehicle. Whereas in the USA, it is a requirement that an electronic on-board recorder (EOBR) is used, which is hard wired to the vehicle management computer. Further, these logbooks may utilise GPS devices in order to determine whether the vehicle being driven is moving or has stopped. This GPS information may also indicate the number of kilometres travelled by the vehicle. However, the data collected on these types of electronic logbook devices is not specifically associated with the driver but instead provides an indication of data associated with the engine of the vehicle or the vehicle itself.

With the increased use of smartphone devices, it is also known for drivers to record their hours of service utilising such devices. These types of systems generally use back-end software to determine whether the driver is complying with the regulations associated with driver related operations. However, these types of devices require that the smartphone is able to connect to a data network in order to transfer the data to a centralised data store. Information associated with the driver may then be extracted from the centralised data store by third parties. With these types of systems however, it is not possible for third parties to access the driver related data from a driver if they are in a location where network connectivity is not possible. That is, in order for driver related data to be transferred from the driver's smartphone it is a requirement that the driver is able to connect to a network. Further, in order for a third party to access the driver related data it is a requirement that the third party is able to connect to a network.

An object of the present invention is to provide an improved driver related data storage system and method.

A further object of the present invention is to provide a driver related data storage system and method that reduces the opportunity for the data to be manipulated.

A further object of the present invention is to provide a driver related data storage system and method that enables the data to be more easily shared by third parties.

Each object is to be read disjunctively with the object of at least providing the public with a useful choice.

The present invention aims to overcome, or at least alleviate, some or all of the afore-mentioned problems.

Further objects and advantages of the invention will be brought out in the following portions of the specification, wherein the detailed description is for the purpose of fully disclosing the preferred embodiment of the invention without placing limitations thereon.

The background discussion (including any potential prior art) is not to be taken as an admission of the common general knowledge in the art in any country. Any references discussed state the assertions of the author of those references and not the assertions of the applicant of this application. As such, the applicant reserves the right to challenge the accuracy and relevance of the references discussed.

### SUMMARY OF THE INVENTION

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components that the use directly references, but optionally also the inclusion of other non-specified components or elements. It will be understood that this intended meaning also similarly applies to the terms mentioned when used to define steps in a method or process.

According to one aspect, the present invention provides a driver related data storage system comprising: a data generation module adapted to generate driver related data; an encryption module adapted to encrypt driver related data; a storage module adapted to store the encrypted driver related data; a code generation module adapted to generate a machine readable code based on the stored encrypted driver related data; and an output module adapted to display the generated machine readable code.

According to a further aspect, the present invention provides a driver related data storage method comprising the steps of: generating driver related data; encrypting the generated driver related data; storing the encrypted driver related data; generating a machine readable code based on the stored encrypted driver related data; and output the generated machine readable code.

### BRIEF DESCRIPTION OF THE DRAWINGS

Embodiments of the present invention will now be described, by way of example only, with reference to the accompanying drawings, in which:

FIG. 1 shows a system block diagram according to an embodiment of the present invention; and

FIG. 2 shows a system block diagram according to a further embodiment of the present invention.

### DETAILED DESCRIPTION OF THE INVENTION

### First Embodiment

Embodiments of the present invention are described herein with reference to a system adapted or arranged to perform a method for generating driver related data, encrypting the data and displaying the encrypted data in the form of a machine readable code.

In summary, the system includes at least a processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the system may include one or more communication devices (wired or wireless) for communicating with external and internal devices, and one or more input/output devices, such as a display, pointing device, keyboard or printing device.

For example, the system may be a smartphone device.

The processor is arranged to perform the steps of a program stored as program instructions within the memory device. The program instructions enable the various methods of performing the invention as described herein to be performed. The program instructions may be developed or implemented using any suitable software programming language and toolkit, such as, for example, a C-based language. Where the device is a smartphone, the program instructions may be installed within the device as a smartphone application, which is downloadable from any suitable Internet service.

Further, the program instructions may be stored in any suitable manner such that they can be transferred to the memory device or read by the processor, such as, for example, being stored on a computer readable medium. The computer readable medium may be any suitable medium, such as, for example, solid state memory, magnetic tape, a compact disc (CD-ROM or CD-R/W), memory card, flash memory, optical disc, magnetic disc or any other suitable computer readable medium.

The system may be arranged to be in communication with external data storage systems or devices in order to retrieve data.

It will be understood that the system herein described includes one or more elements that are arranged to perform the various functions and methods. The following portion of the description is aimed at providing the reader with an example of a conceptual view of how various modules that make up the elements of the system may be interconnected to enable the functions to be implemented.

Further, the following portion of the description explains in system related detail how the steps of the herein described method may be performed. The conceptual diagrams are provided to indicate to the reader how the various data elements are processed at different stages by the various different modules.

It will be understood that the arrangement and construction of the modules may be adapted accordingly depending on system and user requirements so that various functions may be performed by different modules to those described herein, and that certain modules may be combined into single modules.

It will be understood that the modules described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules may be implemented using any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general purpose computing system specifically programmed to perform the described steps. Alternatively, the methods described herein may be implemented using a specific computer system such as an electronic logbook computing device, where the computer has been specifically adapted to perform the described steps on specific data captured from the required data source.

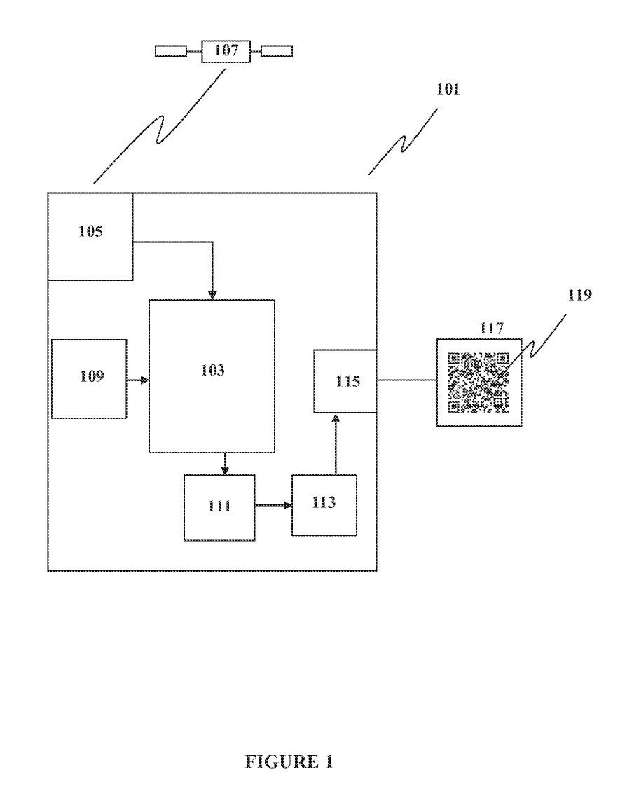

FIG. 1 shows a system block diagram according to this first embodiment.

A smart phone device 101 includes all its required standard functionality in order to perform standard smartphone requirements. In addition, according to this embodiment, a smartphone device 101 has a driver related data generation module 103.

The purpose of the driver related data generation module 103 is to gather data from one or more sources in order to enable a user to record or log their activities.

The generation module 103 collects GPS data from a GPS module 105 that communicates with a GPS satellite device 107. The GPS data collected includes time and/or date stamped location data, such as latitude and longitude data. The GPS data may be collected upon the detection of an appropriate action by the user. For example, the generation module may detect the user pressing an allocated button on the smart phone in order to request that the GPS data is retrieved. Alternatively, other methods are envisaged wherein the generation module may be activated by the user using other means, such as voice activation or gesture recognition, for example.

A data entry module 109 is provided to enable the user to manually enter data into the system. For example, the data may include a driver ID, such as the driver's name. Further, the data may include an activity status indicator indicating whether the user is currently working or resting, for example. Also, the data entered into the system by the user may include details of the vehicle the user is currently driving, current job identification, an employer identification, notes or remarks.

The data entered manually is linked to the GPS data collected from the GPS satellite device. That is, the location data in the form of the latitude and longitude information and the time and/or date data is linked with the manually collected data such that the time and/or date associated with the manually collected data cannot be changed. In other words, the data entered manually by the user is time stamp by the driver related data generation module using the time related data extracted from the GPS data.

The driver related data generation module uses the GPS data and the manually entered data and encrypts this information within an encryption module 111. According to this embodiment, the encryption module generates an MD5 hash from the data generated by the driver related data generation module and signs this data packet using the device's private key. The data packet including the hash is then encrypted using a public key. This encrypted data packet is then stored in a storage module 113.

The encryption of the data packet ensures that the data is not tampered with after the data has been generated. Therefore, the system provides a mechanism of non-repudiation.

The user may cause the driver related data generation module to generate any number of packets of driver related data as the user continues about their activities. For example, the user may activate the generation module every time they change or modify their activity, job or vehicle. For example, the generation module may be activated when the user starts a job, finishes a job or takes a break in the middle of a job. Further, the generation module may be activated when the user decides to make a remark or comment regarding their activities.

Therefore, the storage module 113 may include a number of different encrypted data packets related to the user.

The system further includes a code generation module 115 which is arranged to generate a readable and displayable machine readable code that represents the encrypted data packets. The code generation module is activated upon detecting that the user or a third-party is requesting access to the driver related data. For example, the code generation module may be activated upon the user pressing an allocated button on the smart phone, wherein the code generation module detects the activation of the button and generates the code. Alternatively, a third-party, such as a law enforcement officer, may request that the code generation module is activated and either activate the code generation module themselves by pressing the allocated button or asking the user to press the allocated button.

According to this embodiment, the code is in the form of a QR (Quick Response) code.

An output module in the form of a display module 117 in communication with the code generation module 115 displays the generated code 119 once the code has been generated.

When the code 119 is displayed on the display module 117 a third-party may utilise a code reading module incorporated in a further electronic device to read the code. For example, the code reading module may be a QR code reading module according to this embodiment. The further electronic device utilises a camera on the device to operate in accordance with the code reading module to extract the data from the QR code. Therefore, the third party is able to retrieve the driver related data previously encrypted and stored in the smart phone.

It will be understood that the code generated by the code generation module may be of any other suitable form. For example, as an alternative embodiment the encrypted data packets may be encoded using sound. That is, sound encoded data, for example audio encoded data, may be output by the system for reading by a code reading module in the form of a suitable sound pickup device in proximity to the output module. The output device may be a sound output device such as a speaker or the like. The sound output device may vary depending on the frequency of the sound. It will be understood that the sound frequencies used may be any suitable frequency such as low frequency, high frequency, ultra sound, audible or non-audible frequencies etc. Therefore, the third party is able to retrieve the driver related data previously encrypted and stored in the smart phone using a compatible sound retrieval device.

It can be seen that the driver related data may be generated, encrypted, stored and converted into a machine-readable code for access by a third party without the smartphone being connected to a network. Further, the third-party is able to retrieve the driver related data by scanning the code without their device having to be connected to a network.

Further, as the driver related data is associated with a particular time and/or date which cannot be changed by the user, the third-party reading the data is assured that the data is accurate or valid.

Further, according to the system, it will be understood that the driver is not required to be within the vehicle in order to generate the driver related data.

Optionally, the smartphone may utilise a wireless medium in order to transfer the generated code to a printing device in order to print out the generated code. For example, the wireless medium may be any suitable wireless medium such as Bluetooth.

Also, it will be understood that the data is not tied to a specific vehicle, employer or operator, and may include data related to working when not in the vehicle.

### Second Embodiment

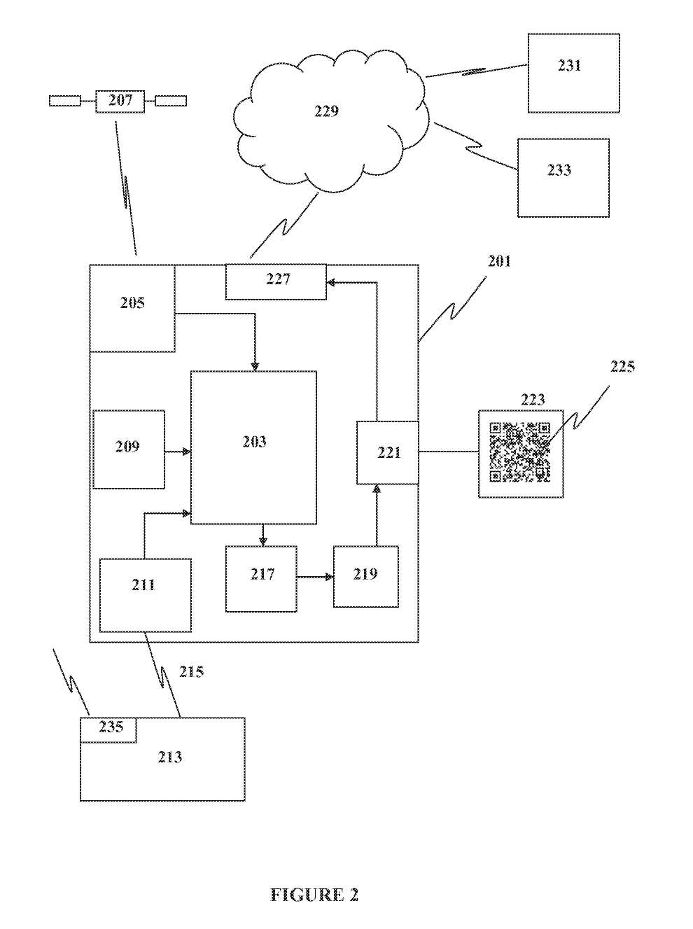

According to this second embodiment of the invention, the same system as described above is incorporated in a smart phone 201 as shown in FIG. 2.

The smart phone 201 includes a driver related data generation module 203 which connects GPS data using a GPS module 205 from a GPS satellite device 207 in the same manner as described above. Further, the smart phone 201 includes a data entry module 209 to collect manually entered data from a user in the same manner as described above.

Additionally, according to this embodiment, the system incorporates a telematics retrieval module 211 which is arranged to be in relocation with a telematics collection module 213 located in the vehicle of the user. The telematics collection module 213 is in wireless communication 215 with the telematics retrieval module 211. For example, the wireless communication medium may be any suitable wireless medium such as Bluetooth.

The telematics collection module 213 collect is telematics data from the vehicle, such as for example, engine status (such as whether the engine is operating or not), engine speed, kilometres travelled or any other vehicle related data associated with the vehicle. For example, the telematics collection module 213 may be incorporated into all connected with the engine management system of the vehicle.

The driver related data generation module 203 utilises the GPS data, manually entered data and telematics data to generate the driver related data and sends this generated data to an encryption module 217. The encryption module 217 generates an MD5 hash from the data generated by the driver related data generation module and signs this data packet using the device's private key. The data packet including the hash is then encrypted using a public key associated with a server 231. As in the first embodiment, this encrypted data packet is then stored in a storage module 219.

As in the first embodiment, the system further includes a code generation module 221 which is arranged to generate a readable and displayable machine readable code 225 that represents the encrypted data packets. The generated code 225 is displayed on a display module 223 to enable a third-party to access the driver related data in the same manner as described above. Further, as an alternative, the code generated may be a sound data file as described above.

According to this embodiment, a communication module 227 arranged to communicate using the GPRS system may also receive the generated code from the code generation module 221. The communication module 227 may then transmit the code via the Internet 229 for storage at a server 231. In this manner, the server 231 stores the electronic logbook entries and is then able to provide access to the generated codes either to the user via their own computer 233 or to third parties who have been provided with access rights to access the codes generated by the user. For example, the third parties may be the employer of the driver, or law officers who are responsible for monitoring drivers to ensure that regulations are being followed.

Further, the user may use their computer 233 to provide a backup of their electronic logbook entries as retrieved from the server 231. Further, the computer 233 may be connected to a suitable printer in order to print off the logbook entries.

Further, as an alternative, rather than the system utilising the GPS device 205 on the smart phone, the GPS device 235 on the vehicle may be used to retrieve the GPS data. The telematics collection module 213 may then transmit the GPS data to the telematics retrieval module 211 in order for the driver related data generation module 203 to generate the driver related data packets.

According to this embodiment, the driver related data generation module may generate the driver related data upon receiving a manual request from the user as described above. Alternatively, the driver related data may be generated at predefined intervals by the system or may be generated upon detection that the vehicle is moving.

### Further Embodiments

It will be understood that the embodiments of the present invention described herein are by way of example only, and that various changes and modifications may be made without departing from the scope of invention.

It will be understood that, as an alternative the code generation module in the above described embodiments may be adapted to generate the code at predetermined intervals. For example, the predetermined period may be a single hour, single day, a predetermined number of days, a single week or a predetermined number of weeks, or indeed any other suitable time period.

It will be understood that, as an alternative, embodiments of the herein described system may include a code request module which is arranged to detect a request for generating the code. For example, the code request module may detect a request sent from a further electronic device via a wireless medium (such as Bluetooth for example). It will be understood that for this alternative solution to work, a third party requesting the code would be required to have an electronic device that includes a corresponding code request module in order to generate the required code request.

1. A driver related data storage system comprising:
a data generation module adapted to generate driver related data;
an encryption module adapted to encrypt driver related data;
a storage module adapted to store the encrypted driver related data;
a code generation module adapted to generate a machine readable code based on the stored encrypted driver related data; and
an output module adapted to output the generated machine readable code.

2. The system of claim 1 where the machine readable code is a displayable code.

3. The system of claim 2 wherein the machine readable and displayable code is a QR code.

4. The system of claim 1 where the machine readable code is sound data.

5. The system of claim 1, wherein the data generation module is further adapted to generate the driver related data automatically at predetermined intervals, upon detection of a telematics event or upon the detection of a data generation request by the user.

6. The system of claim 1, wherein the data generation module is further adapted to generate time related data by activating a GPS device and generate the driver related data based on the time related data.

7. The system of claim 6, wherein the data generation module is further adapted to generate the driver related data such that the driver related data is time stamped with the time related data.

8. The system of claim 6, wherein the data generation module is further adapted to extract the time related data from GPS data received from the GPS device.

9. The system of claim 1, wherein the code generation module generates the code upon activation or receipt of a code request.

10. The system of claim 1, wherein the code generation module is adapted to generate the code at predetermined intervals.

11. The system of claim 10, wherein the predetermined period is one of a single hour, single day, a predetermined number of days, a single week and a predetermined number of weeks.

12. The system of claim 1, wherein the driver related data includes one or more of: the driver's name; the current date; the time associated with particular locations visited on the current date; vehicle telematics data.

13. The system of claim 1 further comprising a telematic information retrieval module adapted to retrieve telematic data from a vehicle associated with the user of the driver related data storage system, wherein the data generation module utilises the retrieved telematic data to generate the driver related data.

14. The system of claim 1, wherein the encryption module is arranged to encrypt the driver related data by generating an MD5 hash signed by a private key associated with the system and encrypt using a server's public key.

15. The system of claim 1, wherein the system forms at least part of a smart phone.

16. The system of claim 1, wherein the system is not required to have telephone network connectivity to generate the code.

17. The system of claim 1, wherein the system is an electronic log book.

18. The system of claim 1, wherein the generation of the code enables secure transfer of the encrypted driver related data via an output device to a device operating a code reader module.

19. The system of claim 18, wherein the device is a smart phone and the output device is a camera inbuilt within the smart phone.

20-39. (canceled)
